(19) United States
(12) Patent Application Publication
(10) Pub. No.: US 2022/0407969 A1
(43) Pub. Date: Dec. 22, 2022

(54) SYSTEM AND METHOD FOR SELECTIVELY SCANNING A PLURALITY OF PAGES FROM A DOCUMENT

(71) Applicant: TOSHIBA TEC KABUSHIKI KAISHA, Tokyo (JP)

(72) Inventor: Hariharasudhan SRINIVASAN, Bangalore (IN)

(73) Assignee: TOSHIBA TEC KABUSHIKI KAISHA, Tokyo (JP)

(21) Appl. No.: 17/693,899

(22) Filed: Mar. 14, 2022

(30) Foreign Application Priority Data
Jun. 21, 2021 (IN) 202141027756

(51) Int. Cl. H04N 1/00; H04N 1/04

(52) U.S. Cl. CPC H04N 1/00482; H04N 1/04; H04N 2201/0094

(57) ABSTRACT

A method for selectively scanning, by a scanning unit including a processor and a memory, a plurality of pages from a document includes the step of receiving, by the scanning unit associated with a Multi-Function Printer (MFP), a user input indicating a plurality of pages to be scanned from the document, the user input including one of a page range or a page skip interval. The method also includes processing, by the scanning unit, the user input for selectively scanning the plurality of pages from the document.

### TECHNICAL FIELD

The present subject matter is related to Multi-Function Printers (MFPs). At least one exemplary non-limiting embodiment is related to methods and systems for selectively scanning a plurality of pages from a document.

### BACKGROUND

Document scanning or imaging is a process of scanning paper documents into paperless digital files. Document scanning is an efficient approach for information management and minimizes use of physical papers for capturing and storing the information. Presently, there are numerous document scanning tools, such as Multi-Function Products (MFPs), paper document scanners and digital scanning applications/software, which convert the paper documents to digital documents and store them in an appropriate storage system.

However, the existing document scanning tools does not allow and/or support scanning only a required set of pages from a document. With the existing document scanning tools, a user needs to scan the complete paper document and then edit a scanned digital file of the document for deleting unwanted pages or retaining preferred pages from the digital file. Having to edit the digital file may become extremely tedious and inconvenient to the user when the document has a large number of pages or when the user is engaged in a time-critical task.

Therefore, it would be advantageous to have a mechanism that allows users to select only the required pages for scanning.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a method for selectively scanning a plurality of pages from a document. The method comprises receiving, by a scanning unit associated with a multi-function printer, a user input, comprising one of a page range or a page skip interval, indicating a plurality of pages to be scanned from the document. Further, the method comprises processing the user input for selectively scanning the plurality of pages from the document.

Further, the present disclosure relates to a scanning unit for selectively scanning a plurality of pages from a document. The scanning unit comprises a processor and a memory. The memory is communicatively coupled to the processor and stores processor-executable instructions, which on execution, cause the processor to receive a user input, comprising one of a page range or a page skip interval, indicating a plurality of pages to be scanned from the document. Further, the instructions cause the processor to process the user input for selectively scanning the plurality of pages from the document.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary, non-limiting embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary environment illustrating a method of selectively scanning a plurality of pages from a document in accordance with non-limiting exemplary embodiments of the present disclosure;

FIG. 2 shows a detailed block diagram of a scanning unit in accordance with non-limiting exemplary embodiments of the present disclosure;

FIG. 3A and FIG. 3B show an exemplary User Interface (UI) for receiving a user input in accordance with non-limiting exemplary embodiments of the present disclosure;

FIG. 3C provides an exemplary illustration of selectively scanning pages of a document based on page range in accordance with non-limiting exemplary embodiments of the present disclosure;

FIG. 3D and FIG. 3E provide exemplary illustration of selectively scanning pages of a document based on page skip interval in accordance with non-limiting exemplary embodiments of the present disclosure;

FIG. 4 shows a flowchart illustrating a method of selectively scanning a plurality of pages from a document in accordance with non-limiting exemplary embodiments of the present disclosure; and

FIG. 5 illustrates a block diagram of an exemplary computer system for implementing non-limiting exemplary embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a scanning unit for facilitating selective scanning of a document on a document scanner and/or a Multi-Function Printer (MFP). In an embodiment, a user may be allowed to select the pages to be scanned by entering an appropriate user input to the scanning unit. As an example, the user may enter a page range or a page skip interval for selecting a required set of pages to be scanned from the document. In other words, the claimed invention allows users to perform a customized scan.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

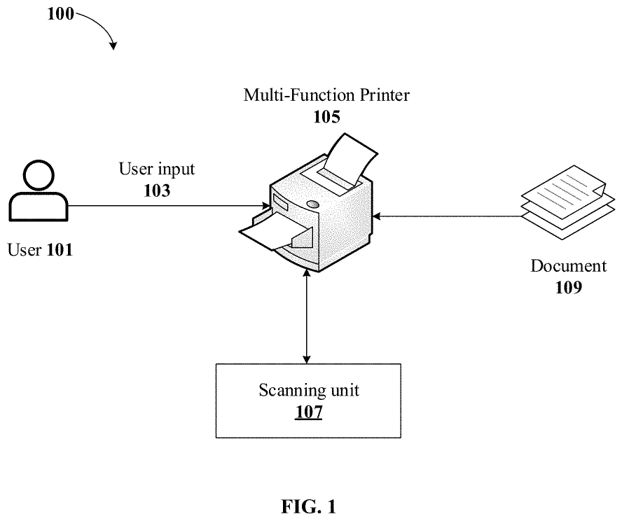

FIG. 1 illustrates an exemplary environment 100 for selectively scanning a plurality of pages from a document 109 in accordance with some embodiments of the present disclosure.

In at least one embodiment, the environment 100 may include, without limiting to, a user 101, a Multi-Function Printer (MFP) 105 and a scanning unit 107 associated with the MFP 105. In at least one embodiment, the user 101 may be an operator of the MFP 105 and/or a person carrying a document 109 to be scanned at the MFP 105. In an embodiment, the user 101 and the MFP 105 may be in the same physical location and the user 101 may access the MFP 105 directly. Alternatively, the user 101 may access the MFP 105 from a remote location using a suitable wired and/or wireless communication interface.

In at least one embodiment, the MFP 105 (also referred as Multi-Function Product, Multi-Function Peripheral or Multi-Function Device) may be any machine that incorporates multiple functionalities including, without limiting to, scanning a document 109, photocopying a document 109, printing a document 109 and the like. In at least one embodiment, the MFP 105 may be configured with a User Interface (not shown in FIG. 1) that allows the user 101 to enter a user input 103 to the MFP 105. As an example, the UI may include, without limiting to, a display screen, a touchpad, a keypad and the like.

In at least one embodiment, the scanning unit 107 may be a computing unit that enables the MFP 105 to selectively scan a plurality of pages of the document 109 based on the user input 103 received from the user 101. In an exemplary non-limiting implementation, the scanning unit 107 may be a stand-alone computing unit that may be associated with the MFP 105 externally as an add-on/plugin device. In another exemplary non-limiting implementation, the scanning unit 107 may be configured within the MFP 105 as a functional module of the MFP 105.

In at least one embodiment, the scanning unit 107 may display a notification and/or prompt message on the UI of the MFP 105, indicating the user 101 to enter the user input 103. In response, the user 101 may enter the user input 103, which comprises a page range or a skip page interval to be considered while scanning the document 109. As an example, the user may enter a page range. The page range may be a numeric range such as 1-10 or 15-18, which indicates that only pages 1 to 10 and 15 to 18 of the document 109 need to be scanned. Alternatively, the user may enter a skip page interval. The skip page interval may indicate a consecutive number of pages that need to be skipped from scanning. As an example, if the skip page interval is ‘3’, then starting from the first page of the document 109, only pages 1, 5, 9 . . . and so on., may be scanned from the document 109. In an exemplary embodiment, the user may choose either of the options from ‘page range’ or ‘skip page interval’ for selecting the pages to be scanned from the document 109.

In at least one embodiment, the user 101 may be allowed to customize/modify the user input 103 as per requirement of the user 101. When no user input 103 has been entered and/or when the user input 103 is an invalid value, then a ‘default’ scanning mode may be followed by the MFP 105. As an example, the ‘default’ scanning mode may include scanning all the pages of the document 109.

In at least one embodiment, after receiving the user input 103, the scanning unit 107 may process the user input 103 to identify the plurality of pages selected by the user 101. Subsequently, the scanning unit 107 may instruct the MFP 105 to scan only the plurality of pages selected by the user 101. In an alternative implementation, the MFP 105 may scan all the pages of the document 109 and save a temporary copy of the scanned document. Subsequently, only the pages selected by the user 101 (i.e., the pages indicated in the user input 103) may be retrieved from the temporary copy of the scanned document and returned as the final scanned document.

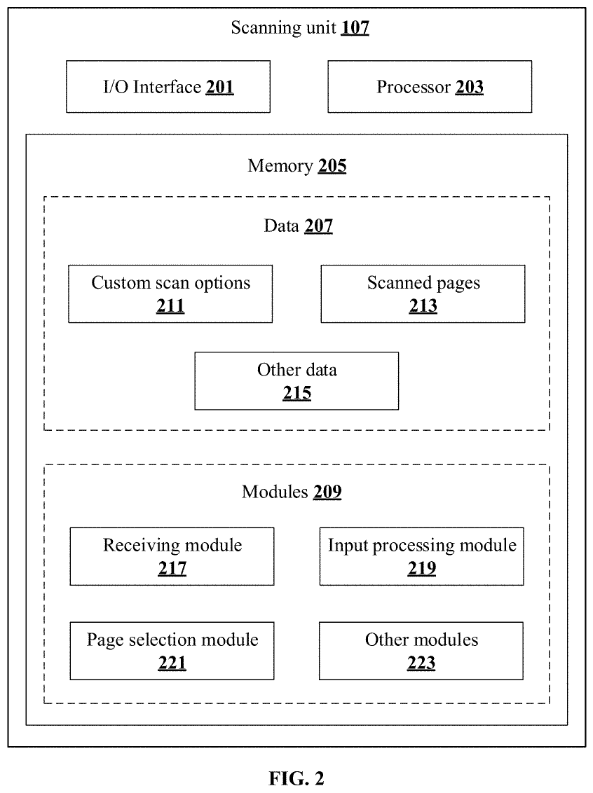

FIG. 2 shows a detailed block diagram of a scanning unit 107 in accordance with an exemplary non-limiting embodiment of the present disclosure.

In some implementations, the scanning unit 107 may include an I/O interface 201, a processor 203 and a memory 205. The I/O interface 201 may be used for communicatively interfacing the scanning unit 107 with a Multi-Function Printer (MFP) 105 that may be used for scanning the document 109. Additionally, the I/O interface 201 may be used for communicatively interfacing the scanning unit 107 with a user device associated with a user 101, for receiving a user input 103 from the user 101. The memory 205 may be communicatively coupled to the processor 203 and may store data 207 and one or more modules 209. The processor 203 may be configured to perform one or more functions of the scanning unit 107 for selectively scanning the plurality of pages from the document 109, using the data 207 and the one or more modules 209.

In at least one embodiment, the data 207 stored in the memory 205 may include, without limitation, custom scan options 211, scanned pages 213 and other data 215. In some implementations, the data 207 may be stored within the memory 205 in the form of various data structures. Additionally, the data 207 may be organized using data models, such as relational or hierarchical data models. The other data 215 may include various temporary data and files generated by the one or more modules 209 while performing various functions of the scanning unit 107. As an example, the other data 215 may include, without limitation, temporarily stored user input 103 and buffers generated while scanning the document 109.

In at least one embodiment, the custom scan options 211 may be the scan options provided to the user 101, for allowing the user 101 to select the plurality of pages to be scanned from the document 109. In an exemplary embodiment, the custom scan options 211 may be provided on the UI of the MFP 105. As an example, the custom scan options 211 may include, without limiting to, a page range scanning option, a skip interval scanning option and a default scanning option. One of the custom scan options 211 selected by the user 101 may be received as the user input 103.

In at least one embodiment, scanned pages 213 may be the plurality of pages that are scanned from the document 109 based on the user input 103. In an embodiment, the scanned pages 213 may be temporarily stored on the scanning unit 107 before creating a digital file. Additionally, a ‘preview’ of the plurality of pages selected by the user 101 may be provided on the UI of the MFP 105, before creating the digital file of the scanned pages 213. Subsequently, the user 101 may be allowed to review the ‘preview’ and modify the user input 103 if there are any changes in the already scanned pages 213.

In at least one embodiment, the data 207 may be processed by the one or more modules 209 of the scanning unit 107. In some implementations, the one or more modules 209 may be communicatively coupled to the processor 203 for performing one or more functions of the scanning unit 107. In an exemplary implementation, the one or more modules 209 may include, without limiting to, a receiving module 217, an input processing module 219, a page selection module 221 and other modules 223.

As used herein, the term module may refer to an Application Specific Integrated Circuit (ASIC), an electronic circuit, a hardware processor (shared, dedicated, or group) and memory that execute one or more software or firmware programs, a combinational logic circuit, and/or other suitable components that provide the described functionality. In an exemplary implementation, each of the one or more modules 209 may be configured as stand-alone hardware computing units. In an embodiment, the other modules 223 may be used to perform various miscellaneous functionalities of the scanning unit 107. It will be appreciated that such one or more modules 209 may be represented as a single module or a combination of different modules.

In at least one embodiment, the receiving module 217 may be configured for receiving the user input 103 and other commands from the user 101, through the UI of the MFP 105. In an embodiment, the input processing module 219 may be configured for processing the user input 103 received from the user 101. Here, the input processing module 219 may decode the user input 103 and identify the pages selected by the user 101. Further, the page selection module 221 may be configured for selecting and/or retrieving only the pages selected by the user from the temporary copy of the scanned document.

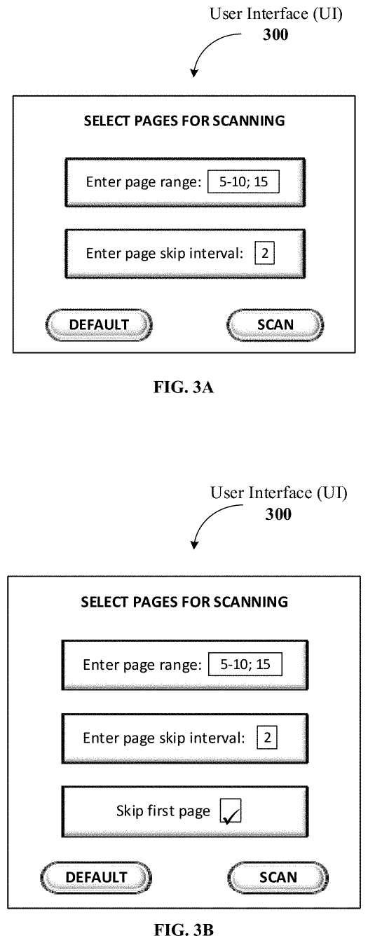

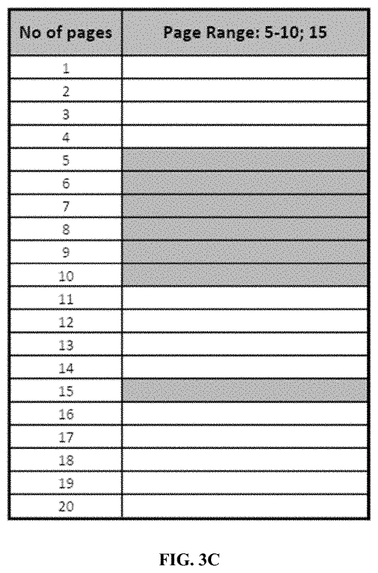

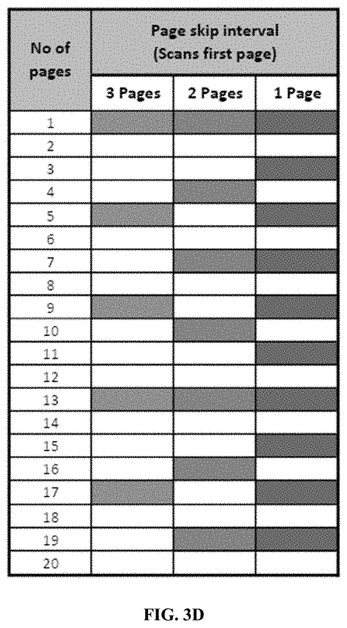

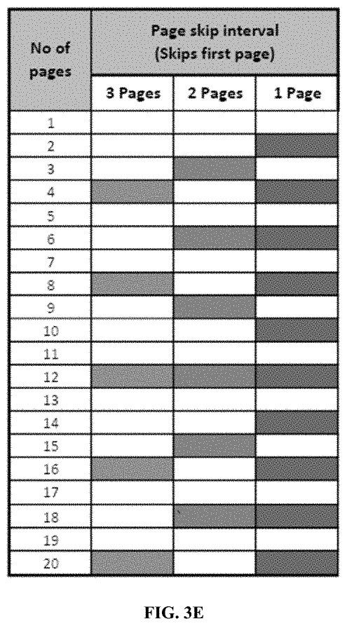

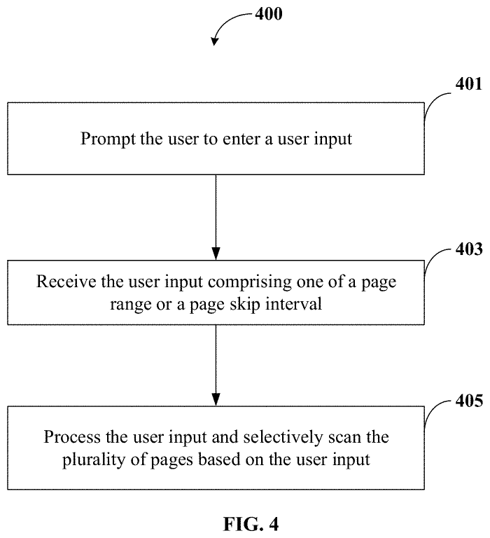

FIG. 3A shows an exemplary UI 300 that may be used for receiving the user input 103 from the user 101. In an exemplary embodiment, the UI 300 may comprise three options for assisting the user 101 in entering the required user input 103. As an example, the UI 300 may provide an option to ‘Enter page range’, ‘Enter page skip interval’ or an option to choose ‘Default’ scanning mode of the MFP 105.

Suppose, if the user 101 intends to scan only a specific range of pages, say pages 5-10 and 15 of the document 109, then the user 101 may specify the required range on the textbox provided next to the ‘Enter page range’ option. Similarly, if the user 101 intends to skip certain pages from being scanned at a regular interval, then the user 101 may specify the required page skip interval on the textbox next to the option ‘Enter page skip interval’. As an example, if the user 101 chooses ‘2’ as the page skip interval, then only those pages that are in multiples of 3 may be selected for scanning. In other words, if a document 109 has 20 pages, then a page skip interval of ‘2’ ensures that only the pages 3, 6, 9, 12, 15 and 18 are scanned and the pages 1, 2, 4, 5, 7, 8, 10, 11, 13, 14, 16, 17, 19 and 20 are skipped from scanning.

In at least one embodiment, the scanning unit 107 may be configured to skip the pages including or excluding the ‘first’ page of the document 109. That is, when the skipping starts from the ‘first’ page of the document 109, even the ‘first’ page of the document 109 may skipped and/or excluded from scanning, causing only the pages 3, 6, 9, 12, 15 and 18 to be scanned from the document 109. Alternatively, when the ‘first’ page is excluded from the ‘page skip interval’, then the pages 1, 4, 7, 10, 13, 16 and 19 may be scanned from the document 109. As a default configuration, the scanning unit 107 may be configured to calculate the page skip interval including the ‘first’ page of the document 109. In an exemplary embodiment, the user 101 may be allowed to override the default configuration by checking/selecting the ‘Skip first page’ option provided on the UI 300, as shown in FIG. 3B.

In at least one embodiment, once the user 101 has entered the required user input 103 (i.e., page range or page skip interval), the user 101 may click on the ‘SCAN’ button presented on the UI 300 to initiate scanning of the document 109. In an exemplary embodiment, when the user 101 does not have a specific set/range of pages to be scanned and also does not wish to skip any pages from scanning, the user 101 may choose a default scanning mode of the MFP 105 by clicking the ‘DEFAULT’ button on the UI 300.

In at least one embodiment, after receiving and processing the user input 103 received from the user 101, the scanning unit 107 may optionally provide a scanned ‘preview’ of the selected pages to the user 101. The user 101 may review the preview and confirm the scanning. On the other hand, when the user 101 prefers to make any changes in the set of documents selected for scanning, the user 101 may be allowed to change the user input 103 using the options available on the UI 300.

FIG. 3C illustrates selection of pages from the document 109 when a page range has been received as the user input 103. As an example, if there are 20 pages in the document 109 and the selected page range is 5-10 and 15, then the scanning unit 107 may scan the whole document and select only the pages 5-10 and 15 for returning as the final scan output to the user. These selected pages are indicated as highlighted boxes in FIG. 3C.

FIG. 3D illustrates selection of pages for different values of ‘page skip interval’ such as 3, 2 and 1. As an example, if there are 20 pages in the document 109 and the ‘page skip interval’ selected by the user is ‘3’, then the pages 1, 5, 9, 13 and 17 may be selected for scanning. Similarly, when the ‘page skip interval’ is 2, only the pages 1, 4, 7, 10, 13, 16 and 19 may be selected for scanning. Similarly, when the selected ‘page skip interval’ is 1, only the alternative pages of the document 109 may be selected for scanning. That is, the pages 1, 3, 5, 7, 9, 11, 13, 15, 17 and 19 may be selected for scanning. Here, the page to be selected for scanning may be identified using the expression (1) given below:

Next page to be scanned=Last page scanned+(Page skip interval+1) (1)

Wherein, at the beginning of the scanning, the variable ‘last page scanned’ may be set to ‘1’ when the ‘page skip interval’ includes the ‘first’ page of the document 109.

FIG. 3E illustrates selection of pages when the user 101 has selected the ‘Skip first page’ option on the UI 300. In this scenario, as an example, when the ‘page skip interval is selected as ‘3’, only the pages 4, 8, 12, 16 and 20 may be selected for the scanning. Here, the variable ‘last page scanned’ of expression (1) may be set to ‘0’, indicating that the ‘first’ page of the document 109 needs to be skipped from scanning.

In at least one embodiment, the scanning unit 107 may be configured in such a way that it causes the MFP 105 to skip the pages, that are not selected by the user, without actually capturing images of those pages. This ensures better performance and faster scanning of the MFP 105. Further, the scanning unit 107 may be configured to stop the scanning once the page range and/or the page skip interval entered by the user 101 is completed.

FIG. 4 shows a flowchart illustrating method of selectively scanning a plurality of pages from a document 109 in accordance with an exemplary non-limiting embodiment of the present disclosure.

As illustrated in FIG. 4, the method 400 may include one or more blocks illustrating a method for selectively scanning pages from a document 109 using a scanning unit 107 illustrated in FIG. 1. The method 400 may be described in the general context of computer executable instructions. Generally, computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 401, the method 400 includes prompting, by the scanning unit 107, a user 101 of the scanning unit 107 and/or a Multi-Function Printer (MFP) 105 associated with the scanning unit 107 to enter a user input 103. The user input 103 may be a numeric value that indicates a set of pages that need to be scanned from a document 109. In an exemplary embodiment, the user input 103 may be received through a User Interface (UI) 300 associated with the scanning unit 107. An exemplary UI 300 for receiving the user input 103 has been illustrated in FIG. 3A.

At block 403, the method 400 includes receiving, by the scanning unit 107, the user input 103 comprising one of a page range or a page skip interval, which indicates the plurality of pages to be scanned from the document 109. As an example, the page range may indicate one or more groups of pages to be selected from the document 109 for scanning. Similarly, the page skip interval may indicate a plurality of pages to be selected for scanning in multiples of the page skip interval. In at least one embodiment, the page skip interval may be calculated starting from a first page of the document 109, as illustrated in FIG. 3C.

At block 405, the method 400 includes processing, by the scanning unit 107, the user input 103 for selectively scanning the plurality of pages from the document 109. In at least one embodiment, processing the user input 103 may include steps of scanning and storing the plurality of pages that are selected based on the user input 103 in a predetermined document format. As an example, the predetermined document format may be one of, without limiting to, ‘.pdf’, ‘.jpeg’ or ‘.jpg’.

In at least one embodiment, the scanning unit 107 may follow a default scanning procedure when there is no user input 103 available. That is, the scanning unit 107 may scan each page of the document 109 when the user input 103 is not received or when a default scanning option is selected by the user 101.

Computer System

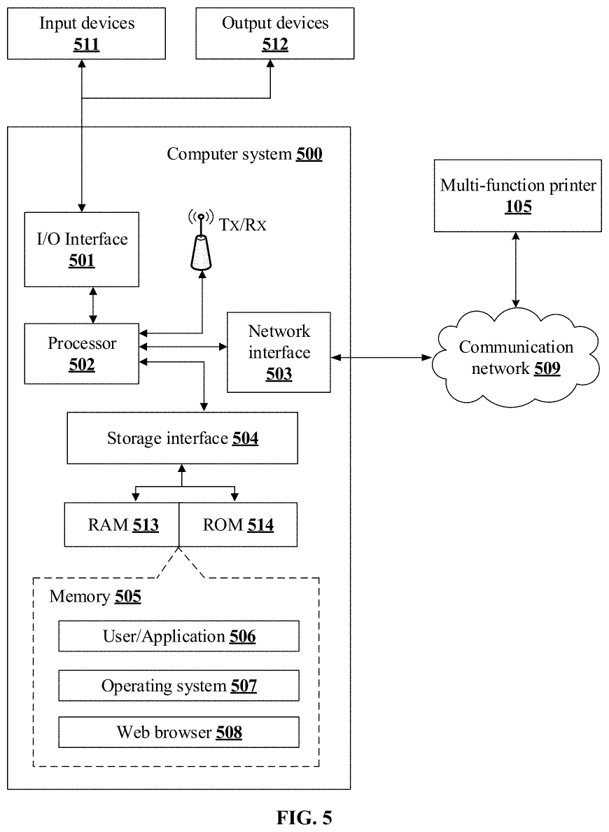

FIG. 5 illustrates a block diagram of an exemplary computer system 500 for implementing exemplary non-limiting embodiments consistent with the present disclosure. In an embodiment, the computer system 500 may be the scanning unit 107 illustrated in FIG. 1, which may be used for selectively scanning a plurality of pages from a document 109. In an alternative embodiment, the computer system may be the Multi-Function Printer (MFP) 105 used for scanning the document 109. The computer system 500 may include a central processing unit (“CPU” or “processor”) 502. The processor 502 may comprise at least one data processor for executing program components for executing user- or system-generated business processes. A user may include any person, application or tool that directly or indirectly operates the computer system 500. The processor 502 may include specialized processing units such as integrated system (bus) controllers, memory management control units, floating point units, graphics processing units, digital signal processing units, etc.

The processor 502 may be disposed in communication with one or more Input/Output (I/O) devices (511 and 512) via I/O interface 501. The I/O interface 501 may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 501, the computer system 500 may communicate with one or more I/O devices 511 and 512.

In at least one embodiment, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc. Using the network interface 503 and the communication network 509, the computer system 500 may connect with the MFP 105 and/or any other computing device associated with the user 101.

In at least one implementation, the communication network 509 may be implemented as one of the several types of networks, such as intranet or Local Area Network (LAN) and such within the organization. The communication network 509 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In at least one embodiment, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application interface 506, an operating system 507, a web browser 508, and the like. In some embodiments, computer system 500 may store user/application data 506, such as the data, variables, records, etc. as described in this invention. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® Os/2®, MICROSOFT® WINDOWS® (XP®, VISTA®/7/8, 10 etc.), APPLE® IOS®, GOOGLE™ ANDROID™, BLACKBERRY® OS, or the like.

The user interface 506 may facilitate display, execution, interaction, manipulation, or operation of program components through textual or graphical facilities. For example, the user interface 506 may provide computer interaction interface elements on a display system operatively connected to the computer system 500, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., Aero, Metro, etc.), web interface libraries (e.g., ActiveX®, JAVA®, JAVASCRIPT®, AJAX, HTML, ADOBE® FLASH etc.), or the like.

The web browser 508 may be a hypertext viewing application. Secure web browsing may be provided using Secure Hypertext Transport Protocol (HTTPS), Secure Sockets Layer (SSL), Transport Layer Security (TLS), and the like. The web browsers 508 may utilize facilities such as AJAX, DHTML, ADOBE® FLASH®, JAVASCRIPT®, JAVA®, Application Programming Interfaces (APIs), and the like. Further, the computer system 500 may implement a mail server stored program component. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In an exemplary embodiment, the computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing exemplary non-limiting embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the embodiments of the present disclosure are illustrated herein.

In at least one embodiment, the present disclosure provides a method for selecting a plurality of pages to be scanned from a document. For example, if a document comprises 100 pages and the user prefers to select only pages 3-5 and 11-14 for scanning, then a traditional scanner may scan each of the 100 pages of the document. Whereas, according to the present disclosure, the scanner may need to scan only pages 1-14, since the user has preferred to skip rest of the pages beyond 14 (i.e., pages 15-100) from scanning. In other words, the present disclosure ensures that the scanner needs to scan a document only until a user-defined limit has been reached (in the above example, user-defined limit is 14). Consequently, the present disclosure makes optimal use of processing and memory resources associated with the scanner.

In at least one embodiment, the present disclosure enhances speed of scanning a document since the user can skip and/or avoid scanning of all the pages in the document. The present disclosure is extremely useful when there are multiple pages to be scanned from multiple documents.

In at least one embodiment, the method of present disclosure improves user convenience and enhances user experience with the scanning, by ensuring that the user need not edit the scanned document after the scanning is complete.

In light of the technical advancements provided by the disclosed method and the scanning unit, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the MFPs and/or other document scanners, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Environment |
| 101 | User |
| 103 | User input |
| 105 | Multi-Function Printer (MFP) |
| 107 | Scanning unit |
| 109 | Document |
| 201 | I/O Interface |
| 203 | Processor |
| 205 | Memory |
| 207 | Data |
| 209 | Modules |
| 211 | Custom scan options |
| 213 | Scanned pages |
| 215 | Other data |
| 217 | Receiving module |
| 219 | Input processing module |
| 221 | Page selection module |
| 223 | Other modules |
| 300 | User Interface (UI) |
| 500 | Exemplary computer system |
| 501 | I/O Interface of the exemplary computer system |
| 502 | Processor of the exemplary computer system |
| 503 | Network interface |
| 504 | Storage interface |
| 505 | Memory of the exemplary computer system |
| 506 | User/Application |
| 507 | Operating system |
| 508 | Web browser |
| 509 | Communication network |
| 511 | Input devices |
| 512 | Output devices |
| 513 | RAM |
| 514 | ROM |

What is claimed is:

1. A method for selectively scanning, by a scanning unit including a processor and a memory, a plurality of pages from a document, the method comprising:
receiving, by the scanning unit associated with a Multi-Function Printer (MFP), a user input indicating a plurality of pages to be scanned from the document, the user input including one of a page range or a page skip interval; and
processing, by the scanning unit, the user input for selectively scanning the plurality of pages from the document.

2. The method as claimed in claim 1, wherein receiving the user input comprises:
displaying one or more custom scan options on a User Interface (UI) associated with the multi-function printer, the one or more custom scan options including at least one of a page range scanning option, a skip interval scanning option, and a default scanning option; and
receiving the user input for the one of the one or more custom scan options through the UI.

3. The method as claimed in claim 1, wherein the page range indicates one or more groups of consecutive pages to be selected from the document for scanning.

4. The method as claimed in claim 1, wherein the page skip interval indicates a plurality of pages to be selected for scanning in multiples of the page skip interval.

5. The method as claimed in claim 4, wherein the page skip interval is calculated starting from a first page of the document, the page skip interval either including the first page or excluding the first page.

6. The method as claimed in claim 1, further comprising scanning each page of the document, in response to at least one of the user input not being received or a default scanning option being selected by a user.

7. The method as claimed in claim 1, wherein processing the user input comprises scanning and storing the plurality of pages selected based on the user input in a predetermined document format.

8. A scanning unit for selectively scanning a plurality of pages from a document, the scanning unit comprising:
a processor; and
a memory, communicatively coupled to the processor, wherein the memory stores processor-executable instructions, which on execution, cause the processor to:
receive a user input indicating a plurality of pages to be scanned from the document, the user input including one of a page range or a page skip interval, and
process the user input for selectively scanning the plurality of pages from the document.

9. The scanning unit as claimed in claim 8, wherein to receive the user input, the processor is configured to:
display one or more custom scan options on a User Interface (UI) associated with the multi-function printer, the one or more custom scan options including at least one of a page range scanning option, a skip interval scanning option, and a default scanning option, and
receive the user input for the one of the one or more custom scan options through the UI.

10. The scanning unit as claimed in claim 8, wherein the page range indicates one or more groups of consecutive pages to be selected from the document for scanning.

11. The scanning unit as claimed in claim 8, wherein the page skip interval indicates a plurality of pages to be selected for scanning in multiples of the page skip interval.

12. The scanning unit as claimed in claim 11, wherein the processor calculates the page skip interval starting from a first page of the document, the page skip interval either including the first page or excluding the first page.

13. The scanning unit as claimed in claim 8, wherein the processor is configured to scan each page of the document, in response to at least one of the user input not being received or a default scanning option being selected by a user.

14. The scanning unit as claimed in claim 8, wherein the processor processes the user input by scanning and storing the plurality of pages selected based on the user input in a predetermined document format.
